(19) United States
(12) Patent Application Publication
(10) Pub. No.: US 2023/0342743 A1
(43) Pub. Date: Oct. 26, 2023

(54) MODULAR MOVIE THEATER

(71) Applicant: Bryce Kesler, Glendale, AZ (US)

(72) Inventor: Bryce Kesler, Glendale, AZ (US)

(21) Appl. No.: 17/725,678

(22) Filed: Apr. 21, 2022

(51) Int. Cl. G06Q 20/20; G06Q 30/06

(52) U.S. Cl. CPC G06Q 20/20; G06Q 30/0645

(57) ABSTRACT

A business method of providing modular, first-run movie theaters that include all the comforts and control of an at-home movie viewing experience while making the process cheaper, less cumbersome, and safer. Each modular theater includes a soundproof enclosure having a limited number of seats, a large viewing screen, surround sound devices, volume and environmental controls, movie pausing control, food and beverage mechanisms, and other unique elements. The modular movie theater can also be accessed and controlled through a computer application run through a mobile computer device.

### BACKGROUND OF THE INVENTION

### 1. Field of the Invention

This invention relates generally to modular movie theaters, and more specifically to modular movie theaters adapted to provide private and custom viewings of first run movies or the like.

### 2. Description of the Related Art

The most common complaints from moviegoers and challenges that traditional first-run movie theater complexes face right now are:
1. High Cost of both tickets and food. Every year, attendance falls, so every year they raise prices to make up the difference. It’s unsustainable and failing.
2. Loud neighbors ruining the experience. Or, you’re the noisy family so you’re embarrassed to go because your family makes too much noise.
3. The effort and rigid time commitments. Therefore, one has to go to a scheduled time, then watch the movie straight through with no ability to pause for water or bathroom break, etc. It’s cumbersome.
4. Safety concerns - people are afraid of sharing an indoor closed space with others given new concerns about Coronavirus and other germs. It’s a much larger concern for some people now, and there’s no good solution for it in a shared auditorium, even with strict cleaning measures.

The following are more stats and thoughts related to how this business method solves the problems and biggest complaints from consumers related to first-run moviegoing in its current form: (Data from Exhibition-At-A-Crossroads from November 2021, annual MPA THEME reports 2018-2022, and from Statista).
- 70% of all respondents in a recent large-participant study, including those who aren’t currently going to the movies, would be upset if theaters went away. So the majority of people, even non-movigoers, want theaters to exist. They just want a better model.
It seems from the data that the 3 biggest issues facing exhibition are:
   1. It’s cumbersome.
      a. You can’t pause the movie.
      b. You can’t turn captions on if you’re having trouble hearing.
      c. You can’t pick your start time, you have to go at the times dictated by the theater schedule.
      d. You can’t be sure you’ll get a good experience - people around you may talk or be on their phones distracting you, and theaters don’t really do any enforcement.
      e. You can’t bring your loud kids - because you may disturb other people.
      f. You can’t talk, even if you and your group would prefer to be able to discuss while watching - because you’ll disturb other people.
      g. You can’t opt out of the trailers, so you will have to sit through the full movie + 20 minutes of trailers without going to the bathroom or taking a break. You end up with a 4-hour commitment round trip including drive time where you control none of the elements of the experience.
      h. You (most of the time) can’t order food from your seat, and if you are, you’re disturbed when it’s delivered.
      i. You can’t bring your own food or order outside food that would better fit your diet or preferences.
      j. You can’t control the temperature.
      k. You can’t even pick the movie you want to watch - at least not if you want to watch something outside the mainstream. You can only pick from the movies that theater has chosen to put onscreen, when there may be 20 or 30 other recently released movies playing in other theaters around the country that are not available at the location you’re in.
      l. You can only watch movies. You can’t watch events, or shows, or play games, or sing karaoke.
      m. The instant movie pod concept solves all of the above, as described.
   2. It’s expensive.
      a. Every year attendance falls. And every year, exhibition raises prices. See Statista charts.
      b. The instant invention solves this by monetizing guests a different way (data) so it can charge less for tickets and concessions while providing a better experience.
   3. It’s unsafe.
      a. Perception that the theater may or may not be clean and free of bacteria, and associated risk. Safety concerns seem to have further amplified all the existing issues first-run theaters were dealing with even before the pandemic.
      b. Private movie pods solve this by ensuring:
         i. You arrive to a clean space - it’s been bathed in FDA-approved UVR lamplight prior to your arrival, which sanitized it against Covid and 99% of all other germs.
         ii. It’s also been cleaned by hand throughout, prior to your arrival.
         iii. During your entire stay, your dedicated heating/cooling ventilation system ensures you are sharing air only with the group you arrived with and no one else.
         iv. The dumbwaiter food delivery option even ensures you can receive your food without anyone entering your space.
   4. Upgrades that are most likely to bring people back:
      a. More space between seats -
         i. The instant invention lets them own the entire space.
      b. Newer seats -
         i. The seats of the instant invention will be brand new, top of the line.
      c. Ability to order food from seat -
         i. The instant invention not only allows that for concessions ordered directly, but you can even order outside food via Grubhub/UberEats/Postmates/etc.
      d. More Large Format Screens
      e. Enforcement of phone usage -
         i. Solved. You and your group are the only people in the auditorium.
      f. Fewer commercials -
         i. The instant invention provides an app that will give people the option to “opt out” of trailers (skip them completely) and also to “build your own” trailer sequence. The instant invention provides them with a list of available trailers and they can pick the four they want to watch. Then that data can be sold.

These complaints and deficiencies have led to big changes in moviegoing habits. In 2021, 53% of the North American population did not attend a single first-run movie. In 2019, that same non-moviegoer category (non-moviegoers) represented only 24% of the population. So there’s a strong trend that more and more people are completely giving up on moviegoing outside the home. Further, there are over 5,000 movie theaters in the country today and some experts think that in 5 years that number will fall to 500. The only remaining ones will be big multiplexes in metropolitan areas that will only play mega-blockbusters. The point is that there’s a gap ready to be filled if a better model can step in.

The instant invention creates a custom, private experience that eliminates all 4 of these concerns while giving you the feel of an at-home experience you control, while honoring the first-run window. A group of people could have the whole auditorium/theater to themselves while watching first-run “only-available-in-theaters” movies along with the ability to pause the movie, adjust the volume to your preferred level, turn captions on or off, and even adjust the temperature to your liking (among other user-controlled elements). Essentially, the perfect at-home movie-viewing experience, but out of the home.

Accordingly, the present invention overcomes the disadvantages associated with the prior art by providing a modular movie theater adapted to provide private and custom viewings of first run movies or the like.

### BRIEF SUMMARY OF THE INVENTION

In view of the foregoing disadvantages inherent in the known types of movie theaters or the like in the prior art, the present invention provides a new and improved modular movie theater. As such, the general purpose of the present invention, which will be described subsequently in greater detail, is to provide a modular movie theater that includes a soundproof enclosure having a limited number of seats, a large viewing screen, surround sound devices, volume and environmental controls, movie pausing control, and food and beverage mechanisms. The modular movie theater could also be accessed and controlled through a computer application run through a mobile computer device. The instant invention includes all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a view of the modular movie theater according to the preferred embodiment of the present invention.

FIG. 2 shows a flow chart for the business method for presenting visual and audio material of the modular movie theater according to the preferred embodiment of the present invention of FIG. 1.

FIG. 3 shows a flow chart for the method of providing a computer system and computer application for the modular movie theater according to the preferred embodiment of the present invention of FIG. 1.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

Most people vastly prefer the experience of watching a movie in the comfort of their own home versus the experience of a crowded auditorium. But studios and movie theaters alike agree that the revenue model is much larger/better when a movie, especially big budget movies, have an exclusive period where it’s “only available in theaters.” What’s missing is an at-home experience out of the home.

The inventive concept could include purchasing depressed real estate with open floor plans in populous areas (for example, grocery stores that have gone out of business and lay dormant for years with no one renting the space) and line them with soundproof, 1 to 8 person, private, programmable “pods” that can be rented on the fly while choosing from a menu of available first-run films. There can also be a bar/restaurant at each location serving food, popcorn, etc., and there can be the ability to bring or order in your own outside food for an upcharge.

The accepted definition of a “first run” industry film or movie or the like is as follows, “The initial period in which a newly released movie is shown exclusively in theaters”.

Pods can be equipped with top-of-the-line screens and stadium recliner seating with comfort items like blankets/pillows, controllable temperature dial, and ice/water machine.

Customers can sign up through an app which gives them access to reserve available pods, from a menu of available movies, and order food & drinks. They can reserve their pod from home or from the on-site restaurant/bar if they’re hanging out there for a while as they get their group together. Start times can be available at every 15-minute increment, so essentially they can pick the time when they’re ready.

The steps involved can include choosing what start time they want and how many people they want their pod to house. Cost is based on pod size. Then picking the first-run movie they’d like to watch off the menu of options. Then they can enjoy a fully private, high quality film viewing experience. Once in the private pod they can talk as much or as little as they want; they can pause the movie for an aggregate of 15 minutes total for bathroom breaks (no rewinding or replaying); they can adjust the volume and the temperature to their liking can order food and have it delivered to their pod, or pickup from the bar; and then, for a few bucks off their bill, they can stay after the film to watch a trailer or two, with or without facial recognition, and provide feedback.

Evidence that there’s an audience for this model is that “Private Watch Parties” at traditional first-run movie theaters have been successful. The problem is PWP’s require you rent out a full auditorium with 20-25 seats at a flat cost of $99-$149, and at a scheduled time. And you pay that high price whether you have 20 people or 2 people in the auditorium. So it only solves the privacy problem and not the pricing or scheduling or safety concern problems.

The instant “Movie pods” redesign conventional pods for movie viewing while keeping the soundproof structure. The inventive movie pods will include comfortable stadium seating with full walls; be wired with a big screen and surround sound; be available in 1, 2, 4, 6 or 8-person pod size; have smart-locks tied to in-app reservations that open only for those that reserved during their reservation time. The movie pods can also have attendants that will thoroughly clean the pods between shows, and UVR lamps that can be turned on between visits to eliminate COVID and other bacteria more thoroughly. Further, each pod may be equipped with a security camera attendants can monitor to ensure proper behavior by guests. Pods may be stand-alone or may be built in rows (like a hallways of hotel-style rooms, each with a lock) with heavy sound-proofing between. And, each pod, since not on any set schedule, won’t be made available to be re-rented until the current users exit and it has been cleaned/prepped.

The instant inventive movie pods will be cheaper than prior movie theaters since they won’t upcharge the food and drink like movie theaters do. They will charge an attractive ticket price, priced by pod size, for example, an average of $6-$10 per person depending on the time of day, paying film rent to studios.

One of the financial advantages of the new movie pods is to gather market research data on trailers and commercials, then packaging and selling data to studios and companies. See revenue streams list below for examples.

The method of business for the inventive movie pods includes:
▪ Customers creating an account upon their first visit where their basic demographics and habits are collected. For example, age, gender, income level, shopping habits, TV channels they watch, products they use, etc. They are made aware that this data is collected so that they can qualify for market research studies (trailers, commercials, products) for credits toward tickets and food.
▪ One example of revenue generation:
   1. A film studio wants consumer insights on their latest horror film trailer. They are looking for a 500-person sample of mostly 18 to 25 year-olds, slightly skewing female, with 50/each Hispanic and African-American respondents included, with facial recognition insights included.
   2. Over the next few days, while in the pods, we offer pod renters of the needed audience demo the option to watch Sony’s horror trailer and provide feedback. In exchange for those 5 minutes of their time, they’ll get a $2.50 discount off their bill. Facial recognition can be used to collect data while they watch, then they’ll answer a few survey questions at the end.
   3. Once the sample is collected per the specifications, we compile it and sell the insights to the film studio. Each person in the 500-person study has now generated additional revenue..
   4. If a pod renter fits the bill for multiple trailers or commercials, let them watch and provide feedback for more than one for a credit each time if they’re willing. It increases the per cap and their discount even more.
   5. Since the pod is not on a set schedule, the variable time spent doing surveys in the pods poses no problem, whether it takes 5 minutes or 20. Pods just won’t be made available to be re-rented until the current renters are finished using it, whenever that is.
   6. If there are pod centers around the country, we can balance for a representative US sample too.

When pods are going unused the system allows users the option to occupy a pod briefly and strictly for the purpose of providing market research in exchange for credits.

Another additional feature would be the ability to allow and provide gaming, streaming when logged into own streaming apps, and/or karaoke within the modular movie theater.

Other features may include:
a. Alerts can pop up on their smart phone asking if they would like the beer they just ordered to be free - in exchange, all you have to do is go in pod # 4 and watch a 2 min trailer. Would you like to accept the offer?
b. Also would plan to make pods rentable by the hour during off hours wherein consumers can use as study rooms, meeting rooms, as a space to project presentations on the screen from a device, etc.
c. Depending on legalities, allow users to rent by the hour and to login to their personal streaming accounts and stream shows/movies using the high quality surround sound and screen.
   1. Therefore, if someone wants to “eventize” the latest Netflix show and binge with their friends, they could rent the pod for 10 hours, login to their Netflix account, and stream to their hearts content.
   2. If someone wants to watch the Lord of the Rings movie from years back that they purchased and have in their Amazon prime account, they can rent a pod for 4 hours, login to their account and stream it.
d. Encourage awareness of the market research offerings so consumers know there’s a good chance they’ll not only pay a cheaper cost to watch a movie than traditional theaters, but depending on what market research opportunities they’re offered, it might end up being significantly cheaper or even free by the end of the night. So it makes a night out even cheaper than one at a normal bar/restaurant, rather than the current perception of movie theaters being incredibly pricy. You don’t even have to go there to watch a movie, you can go there just to eat/drink/hangout while getting a fat discount off your bill each time just for watching a couple trailers or commercials and providing feedback.

The most unique features of the present invention from any other first-run movie theater out there include:
1. A user’s ability to have exclusive use of their own the viewing room. First-run movie theaters do this now in the form of making their large auditoriums rentable, but each auditorium typically has at least 20-25 seats, and they charge a high flat rate whether you have 1 person or 20 (typically they charge $100-$150).
2. The ability to control your own temperature and volume of the movie.
3. The ability to pause the film for an aggregate amount of time (probably 15mins).
4. The ability to pick the start time - any 15 min increment (1:00, 1:15, 1:30, 1:45, 2:00) - of any available pod.
5. The ability to pause the film for an aggregate amount of time (probably 15mins).
6. The ability to turn captions on/off as you’re watching. This feature will also include choosing the language they desire, for example, English or Spanish.
7. Movies run from a server to a 4k high definition tv screen, rather than expensive projector/projection screen.
8. Movie pods are multi-purpose, rentable by the hour - use the screen to login to your own streaming apps and watch shows movies (if no legal issues with that), or to just use as a quiet study room, etc.
9. Interaction-less food and drink delivery. Imagine a sort of “dumbwaiter” built into the wall of each pod where staff can open a small door from the outside, deposit the food and drink, close the door, and then mark as delivered which will ping the patrons inside through their app that their food has been delivered. The patrons then open the door from inside and collect the concessions. (all orders will be through the app, so they can ping the waiter/staff with new food or drink orders, for more ketchup or another pair of silverware, etc. at any time).
10. The incorporation of Covid and germ killing UVR lamps in each pod that can be turned on between groups when no one is present in the room to sanitize the space.
11. The use of video surveillance of each room and an intercom so that if staff sees unwanted behavior they can speak into the room with warnings.
12. The ability to offer opportunity to watch ads and provide feedback for discounts or credits - either through the app or in the pod, and either with or without facial recognition technology included as part of the data collected.
13. The ability to pay for a premium experience, where classic are set up with deep fake/face/voice swap technology so you can load your own faces onto the stars of the film and come to my pods and watch the film with you as the star actor. As such, the user’s information is collected, for example, voice and face samples from users who want the experience and the film and actor they choose would be processed/rendered ahead of time. Then they show up and watch the movie and it’s their voice and face.
14. Blankets/pillows available upon request.
15. Each pod is heavily sound-proofed so there’s no bleed-over sound.
16. UVR lamps, which kill Covid and a broad spectrum of bacteria that run for a few minutes at a time inside each enclosure between visitors.
17. The ability to skip the trailer sequence altogether to save time, or to build-your-own trailer sequence.
18. “Bring-Your-Own-Food” for an upcharge.
19. Ice and water machine in the pod, along with outlets to charge devices.

The following are some likely streams of revenue:
◯ First-run moviepod rentals.
◯ Concessions.
◯ Alcohol/coffee.
◯ Fees for bring-your-own or mobile order your-own food (upcharge to bring outside food)
◯ Monetizing Data
   ▪ Trailer preferences
   ▪ Trailer reactions
   ▪ Market research offers (commercials/trailers/etc. - watch and give feedback)
   ▪ Facial recognition data (sell to companies mining that)
◯ Monetizing film placement and film marketing (film studios would pay for these):
   ▪ Priority placement of a film on the “menu” of film options.
   ▪ Marketing e-blasts promoting a certain film to members.
   ▪ Film swag give-aways.
   ▪ Promotion of older, prior franchise films in lead-up to release of sequel.
   ▪ Themed cocktails or food items promoting a film.
   ▪ Sellable lobby promo space
◯ Subscription model - might institute this down the line once enough data has been gathered.
◯ Rental time for other activities:
   ▪ Gaming
   ▪ Karaoke
   ▪ Streaming app viewing
   ▪ Sporting Events/Concerts/other events

The instant model (since it monetizes customers in other ways) does not need to make as much on food, so the instant invention can sell much cheaper popcorn/soda/candy than traditional theaters. That solves the first bar related to cheaper pricing on staples like popcorn/soda/candy. Other bars can all be solved by allowing customers to bring their own food, or order their own food delivery to their pod (ie, Grubhub and Uber Eats). Therefore:
o Customers will be able to pay me a small upcharge ($5-8/person ballpark) and bring in whatever outside food they want.
◯ Whether someone wants local options, vegan, gourmet, etc., they’re no longer limited.
◯ And the instant invention can have a basic kitchen with less resources devoted to it since the instant invention does not need to provide all options itself.
◯ Customers can still buy the basics from the instant invention right from their seat, ie, burgers, chicken tenders, etc., but if they want something else, they can order it through their favorite food delivery app and have it delivered right to their pod.

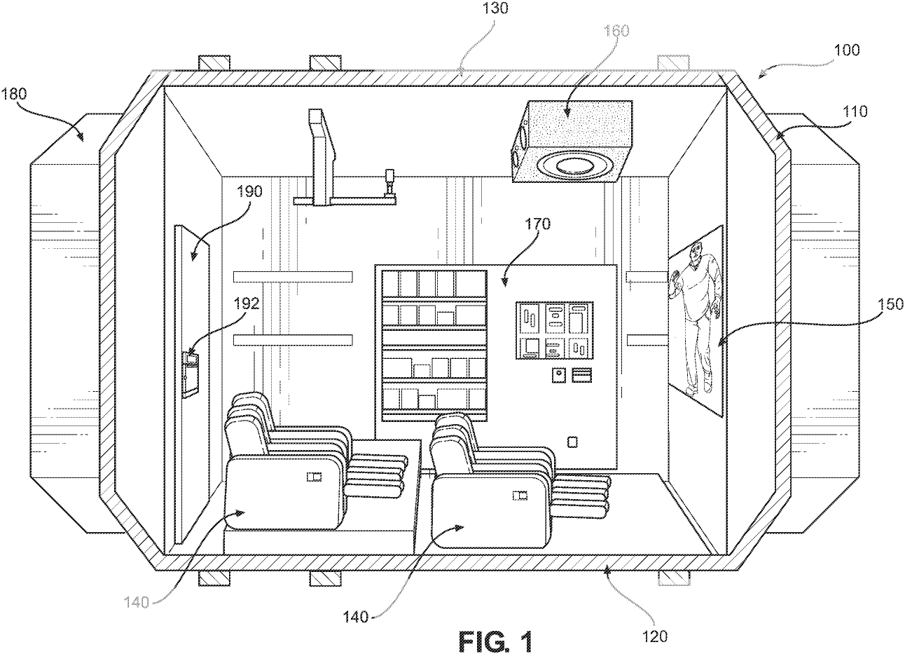

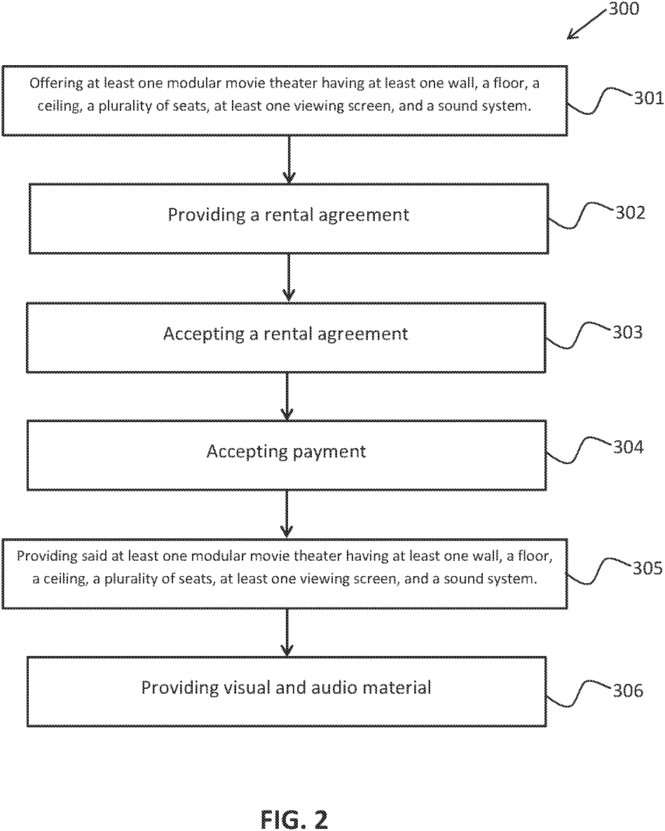

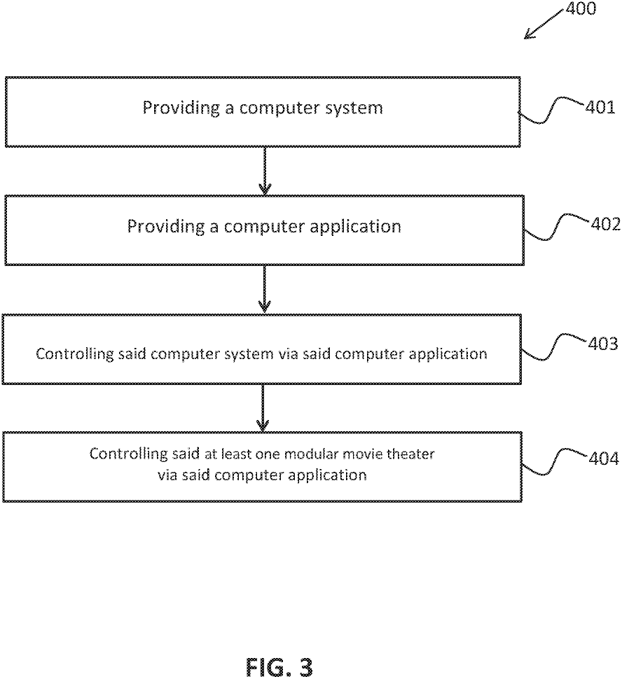

Turning now to FIGS. 1-3, the present invention discloses a modular movie theater 100 along with the business method of presenting visual and audio material comprising the steps, 300-306 and 400-404, of offering at least one modular movie theater 100, step 301, comprising an enclosure including at least one wall 110 completely surrounding the enclosure, a floor 120, and a ceiling 130, wherein the enclosure is adapted to provide a private and sound controlled environment; a plurality of seats 140 removably attached to the floor; and at least one viewing screen 150 adapted to project the visual material and be removably attached to the wall and face the plurality of seats; a sound producing system 160 adapted to project the audio material within the enclosure; providing a rental agreement 302 including offering a choice between any of the at least one modular movie theater; offering a choice of the number of seats to be located within the enclosure; offering a choice of visual and audio material to be viewed upon the viewing screen; offering a choice of times wherein the modular movie theater will be available and wherein the visual material will be available for viewing upon the viewing screen; offering said modular movie theater for a predetermined fee; accepting the rental agreement 303 based upon the choices requested within the rental agreement; accepting payment 304 of the agreed upon price; providing the modular movie theater 305; wherein the modular movie theater includes the number of seats and the visual and audio material chosen; and providing the visual and audio material 306; and wherein the visual and audio material includes the visual and audio material chosen and is presented upon the at least one visual screen.

The choice of visual and audio material may be chosen from a list of first-run industry films. Furthermore, in the preferred embodiment the number of seats is between 1 and 8. Furthermore, the at least one wall of the enclosure may be formed and adapted to block sound from passing therethrough creating a sound proof environment.

The rental agreement may further include offering a choice of viewing locations, wherein the modular movie theater is adapted to be mobile, such that it can be moved from location to location based upon the choice of viewing locations. Structures that can be incorporated to allow transportation from location to location may include axels and wheels, and also can be trucks and trailers.

The business method may further comprise the steps of providing a computer system 401 adapted to control the at least one modular movie theater, produce and provide the rental agreement, accept the rental agreement, and accept payment of the agreed upon price. Furthermore, the business method may further comprising the steps of providing a computer application 402 adapted to be downloaded onto external computer devices and used to communicate with the computer system to create a rental agreement and make payments therethrough. Furthermore, the computer application 402 is adapted to control the computer system 401 to control the at least one modular movie theater and all services thereof.

The business method may further comprise the step of providing food and drinks 170 for predetermined prices, wherein the computer system 401 is further adapted to control the step of providing the food and drinks, and wherein the computer application 402 is further adapted to control the computer system to provide the food and drinks via the computer system, such that users can order food and drinks via the external computer devices. The computer system is further adapted to pause the visual and audio material for an aggregate of 15 minutes, and wherein the computer application is further adapted to control the computer system to pause the visual and audio material for an aggregate of 15 minutes via the computer system, such that users can pause the visual and audio material for an aggregate of 15 minutes via the external computer devices.

The at least one modular movie theater 100 may further comprise a heating, ventilation, and air conditioning system 180, wherein the computer system 401 is further adapted to control the heating, ventilation, and air conditioning system, and wherein the computer application 402 is further adapted to control the heating, ventilation, and air conditioning system via the computer system, such that a user can control the temperature within their respective modular movie theater via one of the external computer devices.

The computer system 401 may be further adapted to control the volume of the sound producing system, and wherein the computer application 402 is further adapted to control the volume of the sound producing system via the computer system, such that users can control the volume of the sound producing system via the external computer devices.

The rental agreement may further include offering a discount for watching additional visual and audio material chosen from a list of visual and audio material consisting of movie trailers and commercials, and offering a discount for providing feedback and opinions after watching the visual and audio material.

The computer application 402 may further be adapted to allow users to create an account in order to download and save personal information therein for future use and convenience. The computer system is further adapted to allow signal streaming from the external computer devices via the computer application to be projected through the at least one viewing screen and the sound producing system. The computer system may be further adapted to allow users to download avatar images and audio samples from the external computer devices via the computer application to replace chosen images and audio within the visual material. The at least one wall of the enclosure further includes a door 190 including a smart lock 192 adapted to be locked and unlocked via the computer application. The computer application is further adapted to turn on and turn off captioning upon and within the visual material.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A business method of presenting visual and audio material comprising the steps of:
offering at least one modular movie theater comprising:
an enclosure including:
at least one wall;
wherein said at least one wall completely surrounds said enclosure;
a floor; and
a ceiling;
wherein said enclosure is adapted to provide a private and sound controlled environment;
a plurality of seats;
wherein said plurality of seats are removably attached to said floor;
at least one viewing screen;
wherein said at least one viewing screen is adapted to project said visual material; and
wherein said at least one viewing screen is adapted to be removably attached to said at least one wall and facing said plurality of seats;
a sound producing system;
wherein said sound producing system is adapted to project said audio material within said enclosure;
providing a rental agreement including:
offering a choice between any of said at least one modular movie theater;
offering a choice of the number of seats to be located within said enclosure;
offering a choice of visual and audio material to be viewed upon said viewing screen;
offering a choice of times wherein said modular movie theater will be available and wherein said visual material will be available for viewing upon said viewing screen;
offering said modular movie theater for a predetermined fee;
accepting said rental agreement based upon the choices requested within said rental agreement;
accepting payment of said agreed upon price;
providing said modular movie theater;
wherein said modular movie theater includes the number of seats and the visual and audio material chosen; and
providing said visual and audio material;
wherein said visual and audio material includes the visual and audio material chosen and is presented upon said at least one visual screen.

2. The business method of claim 1, wherein said choice of visual and audio material are chosen from a list of first-run industry films.

3. The business method of claim 1, wherein said rental agreement further includes offering a choice of viewing locations; and wherein said at least one modular movie theater is adapted to be mobile, such that said at least one modular movie theater can be moved from location to location based upon said choice of viewing locations.

4. The business method of claim 1, wherein the number of said plurality of seats is between 1 and 8.

5. The business method of claim 1, further comprising the steps of:
providing a computer system;
wherein said computer system is adapted to control said at least one modular movie theater;
wherein said computer system is adapted to produce and provide said rental agreement;
wherein said computer system is adapted to accept said rental agreement; and
wherein said computer system is adapted to accept payment of said agreed upon price.

6. The business method of claim 5, further comprising the steps of:
providing a computer application;
wherein said computer application is adapted to be downloaded onto external computer devices and used to communicate with said computer system to create a rental agreement and make payments therethrough.

7. The business method of claim 6, further comprising the steps of:
providing food and drinks for predetermined prices.

8. The business method of claim 7, wherein said computer system is further adapted to control the step of providing said food and drinks; and wherein said computer application is further adapted to control said computer system to provide said food and drinks via said computer system, such that users can order food and drinks via said external computer devices.

10. The business method of claim 6, wherein said computer system is further adapted to pause said visual and audio material for an aggregate of 15 minutes; and wherein said computer application is further adapted to control said computer system to pause said visual and audio material for an aggregate of 15 minutes via said computer system, such that users can pause said visual and audio material for an aggregate of 15 minutes via said external computer devices.

11. The business method of claim 6, wherein each of said at least one modular movie theater further comprises a heating, ventilation, and air conditioning system; wherein said computer system is further adapted to control said heating, ventilation, and air conditioning system; and wherein said computer application is further adapted to control said heating, ventilation, and air conditioning system via said computer system, such that a user can control the temperature within their respective modular movie theater via one of said external computer devices.

12. The business method of claim 6, wherein said computer system is further adapted to control the volume of said sound producing system; and wherein said computer application is further adapted to control said volume of said sound producing system via said computer system, such that users can control said volume of said sound producing system via said external computer devices.

13. The business method of claim 1, wherein said rental agreement further includes offering a discount for watching additional visual and audio material chosen from a list of visual and audio material consisting of movie trailers and commercials.

14. The business method of claim 1, wherein said rental agreement further includes offering a discount for providing feedback and opinions after watching said visual and audio material.

15. The business method of claim 6, wherein said computer application is adapted to allow users to create an account in order to download and save personal information therein for future use and convenience.

16. The business method of claim 1, wherein said at least one wall of said enclosure is adapted to block sound from passing therethrough.

17. The business method of claim 6, wherein said computer system is further adapted to allow signal streaming from said external computer devices via said computer application to be projected through said at least one viewing screen and said sound producing system.

18. The business method of claim 6, wherein said computer system is further adapted to allow users to download avatar images and audio samples from said external computer devices via said computer application to replace chosen images and audio within said visual material.

19. The business method of claim 6, wherein said at least one wall of said enclosure further includes a door including a smart lock adapted to be locked and unlocked via said computer application.

20. The business method of claim 6, wherein said computer application is further adapted to turn on and turn off captioning upon and within said visual material.
